(19) United States
(12) Patent Application Publication
(10) Pub. No.: US 2023/0101812 A1
(43) Pub. Date: Mar. 30, 2023

(54) MONOTONE MEAN-FIELD INFERENCE IN DEEP MARKOV RANDOM FIELDS

(71) Applicants: Robert Bosch GmbH, Stuttgart (DE); Carnegie Mellon University, Pittsburgh, PA (US)

(72) Inventors: Zhili FENG, Stuttgart (DE); Ezra WINSTON, Stuttgart (DE); Jeremy KOLTER, Pittsburgh, PA (US); Devin T. WILLMOTT, Pittsburgh, PA (US); João D. SEMEDO, Pittsburgh, PA (US)

(21) Appl. No.: 17/487,322

(22) Filed: Sep. 28, 2021

(51) Int. Cl. G06N 3/08; G06N 7/00; G06N 5/04

(52) U.S. Cl. CPC G06N 3/08; G06N 7/005; G06N 5/04

(57) ABSTRACT

Methods and systems for inferring data to supplement an input utilizing a neural network, and training such a system, are disclosed. In embodiments, an input is received from a sensor at the neural network. Iterations of approximate probabilities can be determined based on hidden-to-hidden Markov random field (MRF) potentials, observed-to-hidden MRF potentials, and unary MRF potentials. A constant can be identified using a root-finding algorithm. The iterations can continue until convergence. The final iteration of the approximate probability can be used to supplement the input to produce an output.

### TECHNICAL FIELD

The present disclosure relates to computer systems that have capability for artificial intelligence, including neural networks. In embodiments, this disclosure relates to monotone mean-field inference in deep Markov random fields as applied to artificial intelligence.

### BACKGROUND

Mean-field inference is a common strategy for approximate inference in energy-based probabilistic models such as Markov random fields (MRFs). An MRF is similar to a Bayesian network in its representation of dependencies; the differences being that Bayesian networks may be directed and acyclic, whereas Markov networks may be undirected and may be cyclic. Given a set of random variables x={x₁, x₂, . . . , xₙ}, a Markov random field (MRF) defines a probability distribution over all possible sets of values of these variables; for any set of values for these variables x, the MRF defines a probability p(x) for that set of values.

### SUMMARY

According to one embodiment, computer-implemented method for inferring data to supplement an input utilizing a neural network is provided. The method includes receiving an input from a sensor at the neural network; determining a first approximate probability based on hidden-to-hidden Markov random field (MRF) potentials, observed-to-hidden MRF potentials, and unary MRF potentials; identifying a constant using a root-finding algorithm; determining a second approximate probability based on the constant, the hidden-to-hidden MRF potentials, the observed-to-hidden MRF potentials, and the unary MRF potentials; and supplementing the input based on the second approximate probability to produce an output.

According to another embodiment, a computer-implemented method of training a monotone mean-field model for a neural network is provided. The method includes receiving an input dataset at a neural network, wherein the input derives from a sensor; sampling the input dataset; labeling data of the sampled input dataset as either a hidden variable or an observed variable; utilizing an inference algorithm by (i) determining a first approximate probability based on hidden-to-hidden Markov random field (MRF) potentials, observed-to-hidden MRF potentials, and unary MRF potentials, (ii) identifying a constant using a root-finding algorithm, and (iii) determining a second approximate probability based on the constant, the hidden-to-hidden MRF potentials, the observed-to-hidden MRF potentials, and the unary MRF potentials; determining a gradient of loss function with respect to parameters of the inference algorithm; and outputting a trained neural network based on an updated inference algorithm using the gradient of loss function.

According to another embodiment, a system including a machine-learning network is provided. The system includes an input interface configured to receive input data from a sensor, and a processor in communication with the input interface. The processor is programmed to: receive the input data from the sensor; determine a first approximate probability based on hidden-to-hidden Markov random field (MRF) potentials, observed-to-hidden MRF potentials, and unary MRF potentials; identify a constant using a root-finding algorithm; determine a second approximate probability based on the constant, the hidden-to-hidden MRF potentials, the observed-to-hidden MRF potentials, and the unary MRF potentials; and supplement the input based on the second approximate probability to produce an output.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3A depicts a flow chart of an inference (e.g., a monotone mean-field inference) algorithm for the neural network, according to an embodiment.

FIG. 3B depicts a flow chart of an algorithm for training the inference algorithm of FIG. 3A, in an embodiment.

FIGS. 4A-4C depicts observed pixels of an input image (FIG. 4A), a reconstructed image using the teachings herein (FIG. 4B), and the true input image (FIG. 4C), according to an embodiment.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This disclosure considers the problem of approximate inference in (deep) Markov random fields (MRFs), which are pairwise energy-based probabilistic models. As will be described, this disclosure presents a method and system for parameterizing a MRF, and a method for performing inference using this parameterization. The parameterization translates the parameters of the MRF into the parameters of a monotone operator equilibrium network (monDEQ); by carefully choosing the manner in which these parameters are translated, it can be proven that the fixed point of the monotone equilibrium network is exactly equal to the MRF's mean-field global minimum. Monotone operator equilibrium networks (monDEQs) are disclosed in U.S. patent application Ser. No. 16/850,816 titled SYSTEM AND METHOD OF A MONOTONE OPERATOR NEURAL NETWORK, the disclosure of which is hereby incorporated by reference.

These models specify a joint distribution over variables x given by the density

$$p ( x ) ∝ exp ( {\sum }_{( i , j ) ∈ E} {x}_{i}^{⊤} {Φ}_{ij} {x}_{j} + {\sum }_{i = 1}^{n} {b}_{i}^{⊤} {x}_{i} ) .$$

where each x_{1:n} denotes a discrete random variable over kᵢ possible values, represented as a one-hot encoding xᵢ∈{0, 1}^{k}^{ᵢ}; E denotes the set of edges in the model; Φ_{i,j}∈ [symbol] ^{k}^{ᵢ}^{×k}^{ⱼ} represents pairwise potentials; and bᵢ∈ [symbol] ^{k}^{ᵢ} represents unary potential. Depending on context, these models are typically referred to as pairwise Markov random fields (MRFs) or (potentially deep) Boltzmann machines. In this setting, each xᵢ may represent an observed or unobserved value, and there can be substantial structure within the variables. For instance, the collection of variables x may consist of several different “layers” in a joint convolutional structure, leading to the deep convolutional Boltzmann machine.

A task considered in this disclosure is that of performing (conditional) approximate inference in such models. That is, given some portion of observed variables xₒ for O⊆{1, . . . , n} the distribution p(xₕ|xₒ) may be approximated where h=ō, the complement of o. Representing this distribution exactly (e.g. computing its normalizing constant, sampling from the distribution, etc.) is intractable, and thus a common strategy is to employ mean-field inference to approximate the distribution. In mean-field inference, one constructs a factored distribution over xₕ, typically a fully-factorized form given by

$$q ( {x}_{h} ) = {\prod }_{i ∈ h} {q}_{i} ( {x}_{i} )$$

where each qᵢ(xᵢ) ∈{0, 1}^{k}^{ᵢ} represents a distribution over values of the variables xᵢ, and where one aims to find the q(xₕ) the minimizes the KL divergence D_{KL}(q(xₕ)∥|p(xₕ|xₒ)) is possible to analytically solve for one qᵢ if all others are held fixed, leading to the analytical update equations

$${q}_{i} ( {x}_{i} ) := softmax ( {\sum }_{j : ( i , j ) ∈ E} {Φ}_{ij} {q}_{j} ( {x}_{j} ) + {b}_{i} )$$

which are iterated over all variables i ∈h until convergence. Despite its utility, there can be two major drawbacks to typical mean-field inference: 1) the updates are optimizing a non-convex loss surface and thus may get stuck in local optima; and 2) the traditional updates are applied sequentially and thus are difficult to parallelize while still guaranteeing (even this local) convergence. Past attempts to address these problems do so by modifying the updates so as not to necessarily converge to the actual mean-field solution.

In this disclosure, a new parameterization of these probabilistic models and algorithmic approach to mean-field inference that addresses both these challenges is described. The equation above is updated through the lens of a monotone deep equilibrium model (monDEQ). Specifically, this disclosure shows that under certain monotonicity conditions on Φ, the update equations correspond to the unique fixed point of a monDEQ model, owing to the fact that the softmax operator can be derived as the proximal operator of a certain convex function. Motivated by this connection, this disclosure proposes at least two main contributions: First, generic parameterization of a (deep, convolutional) MRF, (i.e., a deep convolutional Boltzmann machine) is defined which guarantees that Φ always obeys these monotonicity conditions; this thereby guarantees that mean-field will always have a unique, globally-optimal fixed point under this parameterization. However, this parameterization does not guarantee that the update equation above necessarily reaches this fixed point, at least not if it is applied in parallel to all the qᵢ(xᵢ) simultaneously (necessary for practical efficiency of the method). To achieve this, a second contribution is disclosed which is a properly-damped parallel mean-field update, based upon a generic proximal operator; although there is no exact closed form solution of this proximal operator, this disclosure derives a very efficient Newton-based implementation.

These approaches are applied to perform both inference and learning for a deep convolutional, multi-resolution MRF, applied to the task of joint image imputation and classification given partially observed images. These networks are applied to modeling MNIST digits and their corresponding classes from partially observed data; while this is naturally a small-scale problem, performing joint probabilistic inference over a complete model of this type is a relatively high-dimensional task as far as traditional mean-field inference is concerned.

This disclosure builds on three main avenues of work: 1) the broad topic of energy-based deep model and Markov random fields (MRFs) in particular, 2) deep equilibrium models (DEQs), especially their convergent version, the monotone DEQ; and 3) concave potentials and parallel methods for mean-field inference. Each of these will be briefly summarized.

Regarding equilibrium models and their provable convergence, based on the observation that a neural network with input injection z^{t+1}=σ(W_{z}_{ₜ}+Ux+b) usually converges to a fixed point, an effectively infinite-depth network can be modeled with input injection directly via its fixed point: z*=σ(Wz*+Ux+b). Its backpropagation is done through the implicit function theorem and only requires constant memory. The multiscale DEQ models achieve near state-of-the-art performances on many large-scale tasks. A parametrization of the DEQ (denoted as monDEQ) can guarantees provable convergence to a unique fixed point, using monotone operator theory. Specifically, W can be parametrized in a way that I−W≥mI (called m-strongly monotone) is always satisfied during training for some m>0; nonlinearities can be converted into proximal operators (which include ReLU, tan h, etc.), and using existing splitting methods like forward-backward and Peaceman-Rachford can provably find the unique fixed point.

Regarding Deep MRF, MRF is a form of energy-based model, which model joint probabilities of the form p_{θ}(x)=exp(−E_{θ}(x))/Z_{θ} for an energy function E_{θ}. A common type of MRF is the Boltzman machine, and its deep (multi-layer) variant. Particularly, RBMs define E_{θ}(v, h)=−a^{T}v−b^{T}h−v^{T}Wh, where θ={W, a, b}, and v is the set of visible variables, and h is the set of latent variables. It is usually trained using the contrastive-divergence algorithm, and its inference can be done efficiently by a block mean-field approximation. However, a particular restriction of RBMs is that there can be no intra-layer connections, that is, each variable in v (resp. h) is independent conditioned on h (resp. v). By contrast, the formulation disclosed in this disclosure allows intra-layer connections and is therefore is more expressive in this respect.

Regarding parallel and convergent mean-field, it is well-known that mean-field updates converge locally using a coordinate ascent algorithm. However, local convergence is only guaranteed if the update is applied sequentially. Nonetheless, several works have proposed techniques to parallelize updates. However, unlike the approach disclosed herein, these previous works do not use a parameterization which ensures a global mean-field optimum, and their algorithm therefore does not converge to the actual fixed point of the mean-field updates. This is because prior works used the prox_{f}¹ proximal operator (described below), whereas we derive the prox_{f}^{σ} operator to guarantee global convergence when doing mean-field updates in parallel.

Technical contributions of this disclosure will now be described. First, this disclosure begins by illustrating the connection between a (joint) mean-field inference fixed point and the fixed point of a monotone DEQ model; this establishes that, under proper conditions on Φ, there exists a unique globally-optimal mean-field fixed point. This disclosure then presents a parameterization of the pairwise potentials in a deep probabilistic model that guarantees this monotonicity condition, and discuss how deep structured networks can be implemented in this form. And finally, this disclosure presents an efficient parallel method for computing this mean-field fixed point, again motivated by the machinery of monotone DEQs and operator splitting methods.

### Mean-Field Inference as a Monotone DEQ

Regarding how to formulate the mean-field inference as a DEQ update, recall that this disclosure is modelling a distribution of the form

$$p ( x ) ∝ exp ( {\sum }_{( i , j ) ∈ E} {x}_{i}^{⊤} {Φ}_{ij} {x}_{j} + {\sum }_{i} {b}_{i}^{⊤} {x}_{i} ) .$$

This disclosure is interested in approximating the conditional distribution p(xₕ|xₒ), where o and h denote the observed and hidden variables respectively, with a factored distribution q(xh)=Π_{i∈h} qᵢ(xᵢ). Here, the standard mean-field updates (which minimize the KL divergence between q(xₕ) and p(xₕ|xₒ) over the single distribution qᵢ(xᵢ)) are given by

$${q}_{i} ( {x}_{i} ) := softmax ( {\sum }_{j : ( i , j ) ∈ E} {Φ}_{ij} {q}_{j} ( {x}_{j} ) + {b}_{i} )$$

where, overloading notation 125 slightly, we let qⱼ(xⱼ) denote a one-hot encoding of the observed value for any j ∈o.

The essence of the above updates is a characterization of the joint fixed point to mean-field inference. For simplicity of notation, defining the design matrices

$$q = [ \begin{matrix}{q}_{1} ( {x}_{1} ) \\ {q}_{2} ( {x}_{2} ) \\ ⋮\end{matrix} ] , Φ = [ \begin{matrix}0 & {Φ}_{12} & {Φ}_{13} & ⋯ \\ {Φ}_{12}^{T} & 0 & {Φ}_{23} & ⋯ \\ {Φ}_{13}^{T} & {Φ}_{23}^{T} & 0 & ⋯ \\ ⋮ & ⋮ & ⋮ & ⋱\end{matrix} ] .$$

one can see that qₕ is a joint fixed point of all the mean-field updates if and only if

qₕ=softmax(Φₕₕqₕ+Φₕₒxₒ+bₒ)

where xₒ analogously denotes the stacked one-hot encoding of the observed variables.

Given input vector x, a monotone DEQ computes the fixed point z*(x) that satisfies the equilibrium equation

z*(x)=σ(Wz*(x)+Ux+b).

If: 1) σ is given by a proximal operator σ(x)=prox_{f}¹(x) for some convex closed proper (CCP) f and 2) if we have the monotonicity condition I−W≥mI (in the positive semidefinite sense) for some m>0, then for any x there exists a unique fixed point z*(x), which can be computed through standard operator splitting methods, such as forward-backward splitting.

Therefore, under certain conditions the mean-field fixed point can be viewed as the fixed point of an analogous monotone DEQ. This is formalized in the following proposition. Suppose that the Φ matrix defined above satisfies I−Φ≥mI for m>0. Then the mean-field fixed point

qₕ=softmx(Φₕₕqₕ+Φₕₒxₒ+bₒ)

corresponds to the fixed point of a monotone DEQ model. Specifically, this implies that for any xₒ, there exists a unique, globally-optimal fixed point of the mean-field distribution qₕ.

As the monotonicity condition of the monotone DEQ is assumed in the proposition, the proof of the proposition rests entirely in showing that the softmax operator is given by prox_{f}¹ for some CCP f. Specifically, this is the case for

$$f ( z ) = {\sum }_{i} {z}_{i} log {z}_{i} - \frac{1}{2} {‖ z ‖}_{2}^{2} + I \{ {\sum }_{i} {z}_{i} = 1 , {z}_{i} \geq 0 \}$$

i.e., the restriction of the entropy minus squared norm to the simplex (note that even though we are subtracting a squared norm term it is straightforward to show that this function is convex, since the second derivatives are given by

$$\frac{1}{{z}_{i}} - 1 ,$$

which is always non-negative over its domain).

### A Monotone Parameterization of Deep Pairwise Models

A takeaway from the proceeding section is that if one parameterizes the probabilistic model in a way that the pairwise potentials satisfy I−Φ≥mI then there will exist a unique mean-field inference solution (technically speaking, one only needs I−Φₕₕ≥mI, but since one wants this to hold for any choice of h, one needs the condition to apply the entire Φ matrix). Additionally, owing to the definition of this matrix, Φ is a block hollow matrix (that is, the kᵢ×kᵢ diagonal blocks corresponding to each variable must be zero). While both these conditions on Φ are convex constraints, in practice it would be extremely difficult to project a generic set of weights onto this constraint set under an ordinary parameterization of the network.

Thus, a non-convex parameterization of the network weights is disclosed, but one which guarantees that the monotonicity condition is always satisfied, without any constraint on the weights in the parameterization. Specifically, define the block matrix

A=[A₁ A₂. . . Aₙ]

with Aᵢ ∈ [symbol] ^{d×k}^{ₜ} matrices for each variables, and where d can be some arbitrarily chosen dimension. Then let Aᵢ be a spectrally-normalized version of Aᵢ

Âᵢ=Aᵢ·min{\sqrt{1−m}/∥Aᵢ∥₂,1}

i.e., a version of Aᵢ normalized such that its largest singular value is at most \sqrt{1−m} (note that one can compute the spectral norm of Aᵢ as ∥Aᵢ∥₂=∥Aᵢ^{T}Aᵢ∥₂^{1/2}, which involves computing the singular values of only a kᵢ×kᵢ matrix, and thus is very fast in practice). The Â matrix is defined analogously as the block version of these normalized matrices.

This disclosure proposes to parameterize Φ as

Φ=blk diag(Â^{T}Â)−Â^{T}Â

where blk diag denotes the block-diagonal portion of the matrix along the kᵢ×kᵢ block. Put another way, this parameterizes Φ as

$${Φ}_{ij} = \{ \begin{matrix}- {\hat{A}}_{i}^{T} {\hat{A}}_{j} & if i \neq j , \\ 0 & if i = j .\end{matrix}$$

This parameterization guarantees both hollowness of the Φ matrix and monotonicity of I−Φ, for any value of the A matrix. For any choice of parameters A, under the parametrization equation for Φ above, we have that 1) Φᵢᵢ=0 for all i=1, . . . , n, and 2) I−Φ≥mI.

Block hollowness of the matrix follows immediately from construction. To establish monotonicity, note that

I−Φ [symbol] mI⇔I+Â^{T}Â−blk diag(Â^{T}Â) [symbol] mI ⇐I−blk diag(Â^{T}Â) [symbol] mI ⇔I−Âᵢ^{T}Âᵢ [symbol] mI,∀i ⇔∥Âᵢ∥₂≤\sqrt{1−m},∀i.

This last property always holds by the construction of Âᵢ.

This construction guarantees monotonicity of the resulting pairwise probabilistic model. However, instantiating the model in practice, where the variables represent hidden units of a deep architecture (i.e., representing multi-channel image tensors with pairwise potentials defined by convolutional operators), requires substantial subtlety and care in implementation. In this setting, one may not want to actually represent A explicitly, but rather determine a method for multiplying Av and A^{T} v for some vector v (as we will see shortly, this is all that is required for the parallel mean-field inference method we propose in the next section). This means that certain blocks of A are typically parameterized as convolutional layers, with convolution and transposed convolution operators as the main units of computation.

More specifically, the full set of hidden units may be partitioned into some K distinct sets

$$q = [ \begin{matrix}{q}_{1} \\ {q}_{2} \\ ⋮ \\ {q}_{K}\end{matrix} ]$$

where e.g., qᵢ would be best represented as a height×width×groups x cardinality tensor (i.e., a collection of a multiple hidden units corresponding to different locations in a typical deep network hidden layer). Note that here qᵢ is not the same as qᵢ(xᵢ), but rather the collection of many different individual variables. These qᵢ terms can be related to each other via different operators, and a natural manner of parameterizing A in this case is as an interconnected set of a convolutional or dense operators. To represent the pairwise interactions, a similarly-factored A matrix is presented, e.g., one of the form

$$A = [ \begin{matrix}{A}_{11} & 0 & … & 0 \\ {A}_{21} & {A}_{22} & … & 0 \\ ⋮ & ⋮ & ⋱ & ⋮ \\ {A}_{K 1} & {A}_{K 2} & … & {A}_{KK}\end{matrix} ]$$

where e.g., Aᵢⱼ is a (possibly strided) convolution mapping between the tensors representing qⱼ and qᵢ. It is therefore possible to parameterize complex convolutional multi-scale deep pairwise probabilistic models, all while ensuring monotonicity.

### Efficient Parallel Solving for the Mean-Field Fixed Point

Although the monotonicity of the mean-field fixed point guarantees the existence of a unique solution, it does not necessarily guarantee that the simple iteration

qₕ^{(t)}=softmax(Φₕₕqₕ^{(t-1)}+Φₕₒxₒ+bₕ)

will converge to this solution. Instead, to guarantee convergence, one needs to apply the damped iteration:

qₕ^{(t)}=prox_{f}^{a}((1−a)qₕ^{(t-1)}+a(Φₕₕqₕ^{(t-1)}+Φₕₒxₒ+bₕ)).

The damped forward-backward iteration converges linearly to the unique fixed point if σ≤2m/L², assuming I−Φ is m-strongly monotone and L-Lipschitz. Crucially, this update can be formed in parallel over all the variables in the network: coordinate descent approach is not required as is typically needed by mean-field inference.

A key issue though is that while prox_{f}¹(x)=softmax(x) for f defined above (and recited again below):

$$f ( z ) = {\sum }_{i} {z}_{i} log {z}_{i} - \frac{1}{2} {‖ z ‖}_{2}^{2} + I \{ {\sum }_{i} {z}_{i} = 1 , {z}_{i} \geq 0 \}$$

in general this does not hold for a≠1. Indeed, for a≠1, there is no closed form solution to the proximal operation, and computing the solution is substantially more involved. Specifically, computing this proximal operator involves solving the optimization problem

$${prox}_{f}^{α} ( x ) = {arg min}_{z} \frac{1}{2} {‖ x - z ‖}_{2}^{2} + α {\sum }_{i} {z}_{i} log {z}_{i} - \frac{α}{2} {‖ z ‖}_{2}^{2}$$

$$subject to {\sum }_{i} {z}_{i} = 1 , z \geq 0.$$

The following theorem therefore characterizes the solution to this problem for a∈ (0,1) (although it is also possible to compute solutions for a>1, this is not needed in practice, as it corresponds to a “negatively damped” update, and it is typically better to simply use the softmax update in such cases).

Given f as defined in the equation that was repeated again above, a∈(0,1), and xᵢ ∈ [symbol] ^{k}, the proximal operator prox_{f}^{a}(x) is given by

$${prox}_{f}^{α} ( {x}_{i} ) = \frac{α}{1 - α} W ( \frac{1 - α}{α} exp ( \frac{{x}_{i} - α + λ}{α} ) ) ,$$

where λ∈ [symbol] is the unique solution chosen to ensure that the resulting Σᵢ prox_{f}^{a}(xᵢ), and where W(.) is the principal branch of the Lambert W function.

In practice, however, this is not the most numerically stable method for computing the proximal operator, especially for small a, owing to the large term inside the exponential. Computing the prox operation efficiently is somewhat involved, though briefly, the alternative function is defined:

$$ℊ ( y ) = log \frac{α}{1 - α} W ( \frac{1 - α}{α} exp ( \frac{y}{α} - 1 ) )$$

and show how to directly compute g(y) using Halley's method (note that Halley's method is also the preferred manner to computing the Lambert W function itself numerically. Finding the prox operator then requires that we find λ such that Σᵢ₌₁^{k} exp(g(xᵢ+λ))=1. This can be done via (one-dimensional) root finding with Newton's method, which is guaranteed to always find a solution here, owing to the fact that this function is convex monotonic for λ∈(−∞, 1). The gradients of the g function are computed along with the proximal operator itself via implicit differentiation (i.e., we can do it analytically without requiring unrolling the Newton or Halley iteration).

Finally, before applying these teachings to the Figures described below, this disclosure will provide approaches for training these monotone mean-field models, exploiting their efficient approach to mean-field inference. Probabilistic models are typically trained via approximate likelihood maximization, and since the mean-field approximation is based upon a particular likelihood approximation, it may seem most natural to use this same approximation to train parameters. In practice, however, this is often a suboptimal approach. Specifically, because the forward inference procedure described herein ultimately uses mean-field inference, it is better to train the model directly to output the correct marginals, when running this mean-field procedure. In the context of monotone mean-field models, this procedure has a particularly convenient form, as it corresponds roughly to the “typical” training of DEQ.

In more detail, suppose one is given a sample x ∈X (i.e., at training time the entire sample is given), along with a specification of the “observed” and “hidden” sets, o and h respectively. Note that the choice of observed and hidden sets is potentially up to the algorithm designer, and can effectively allow one to train the mean-field models in a “self-supervised” fashion, where the goal is to predict some unobserved components from others. In practice, however, one typically wants to design hidden and observed portions congruent with the eventual use of the model: e.g., if one is using the model for classification, then at training time it makes sense for the label to be “hidden” and the input to be “observed.”

Given this sample, the mean-field inference problem is solved to find qₕ*(xₒ) such that

qₕ*=softmax(Φₕₕqₕ*+Φₕₒxₒ+bₒ).

For this sample, the true value of the hidden states is given by xₕ. Thus, some loss function [symbol] (qₕ*, xₕ) can be applied between the prediction and true value, and update parameters of the model θ={A, b} using their gradients

$$\frac{\partial ℓ ( {q}_{h}^{★} , {x}_{h} )}{\partial θ} = \frac{\partial ℓ ( {q}_{h}^{★} , {x}_{h} )}{\partial {q}_{h}^{★}} \frac{\partial {q}_{h}^{★}}{\partial θ} = \frac{\partial ℓ ( {q}_{h}^{★} , {x}_{h} )}{\partial {q}_{h}^{★}} {( I - \frac{\partial ℊ ( {q}_{h}^{★} )}{\partial {q}_{h}^{★}} )}^{- 1} \frac{\partial ℊ ( {q}_{h}^{★} )}{\partial θ}$$

with g(qₕ*)≡softmax(Φₕₕqₕ*+Φₕₒxₒ+bₒ) and where the last equality comes from the standard application of the implicit function theorem as typical in DEQs or monotone DEQs. This backward pass can also be computed via an iterative approach.

Owning to the restricted range of weights allowed by the monotonicty constraint, the actual output marginals qᵢ(xᵢ) are often more uniform in distribution than desired. Thus, the loss can be applied to a scaled marginal

\tilde{q}ᵢ(xᵢ)∝qᵢ(xᵢ) [symbol] ^{ᵢ}

where τᵢ ∈ [symbol] ₊ is a variable-dependent temperature parameter. Importantly, this is only done after [symbol] convergence to the mean-field solution, and thus only applies to the marginals to which a loss is applied: the actual internal iterations of mean-field might not have such a scaling, as it may violate the monotonicity condition.

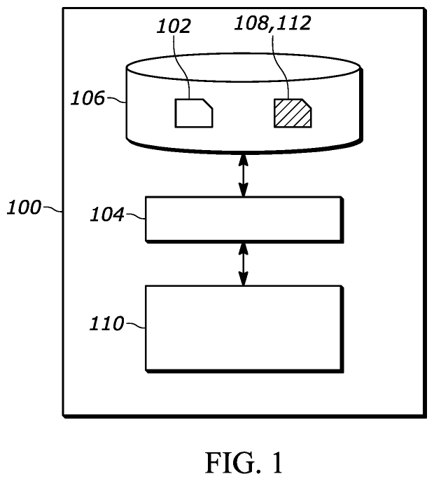

Reference is now made to the embodiments illustrated in the Figures, which can apply these teachings to a machine learning model or neural network. FIG. 1 shows a system 100 for training a neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

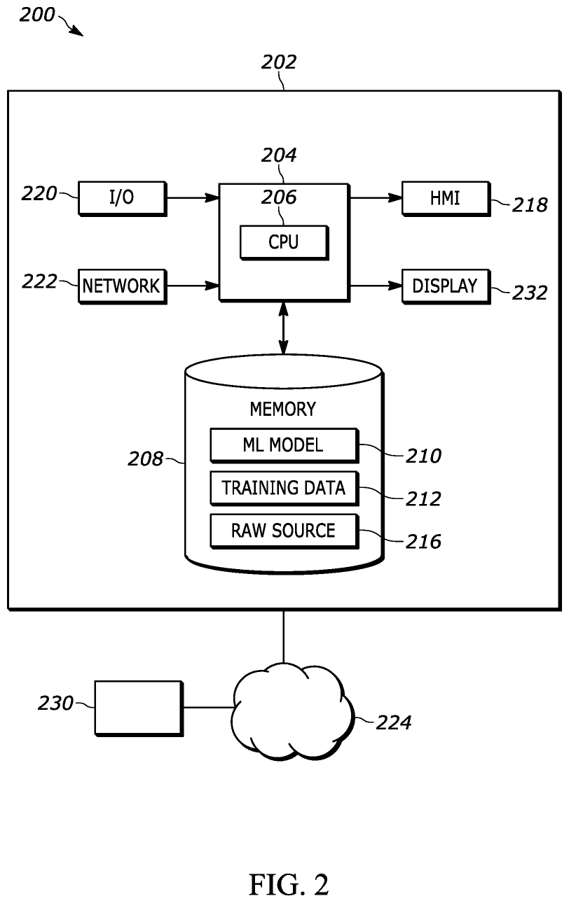

FIG. 2 depicts a system 200 to implement the monotone mean-field inference models described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction stet such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 330 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

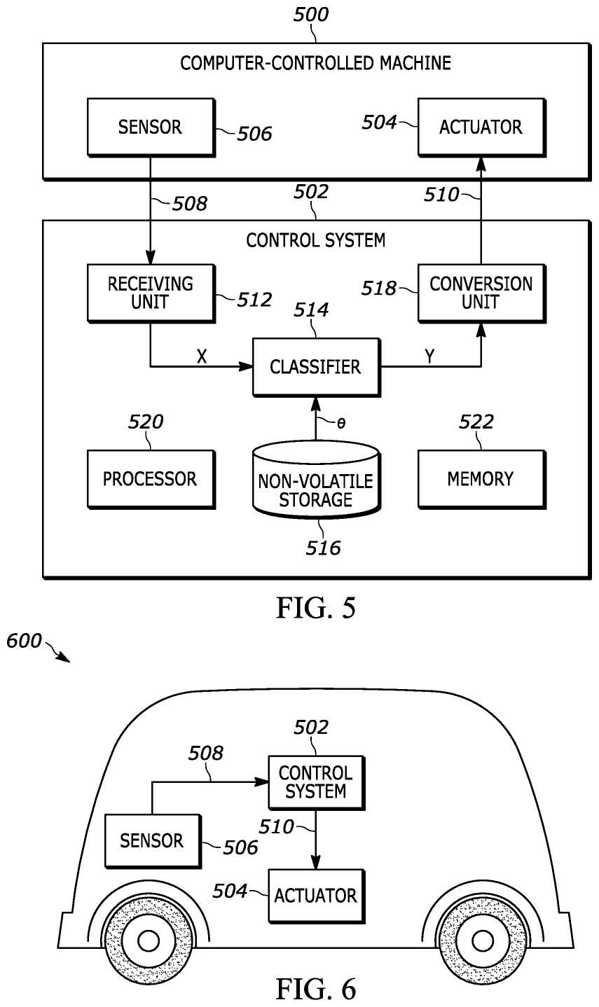

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). Several different examples of inputs are shown and described with reference to FIGS. 5-11. In some examples, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a pedestrian in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., pedestrian). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In an example, the raw source data 216 may include image data representing an image. Applying the machine-learning algorithm (e.g., monotone mean-field inference model) described herein, the output can be a supplemented version of the input image that more closely resembles the actual object depicted in the image. This can be done by using Markov random fields, as described.

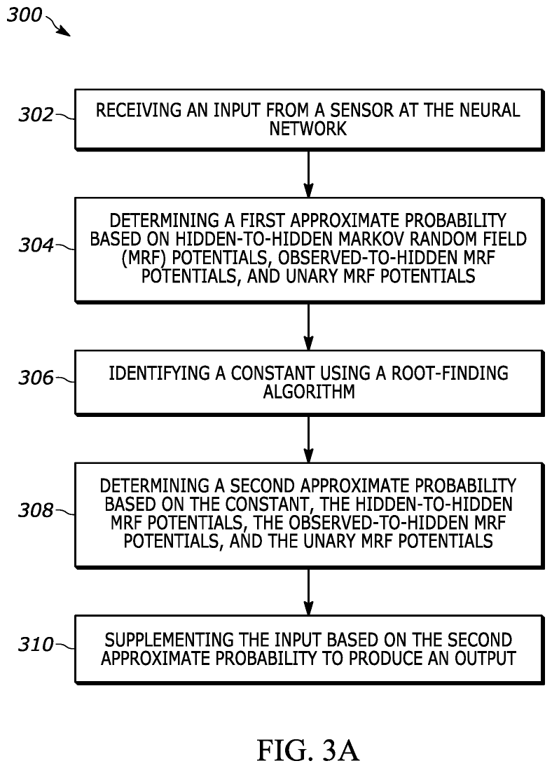

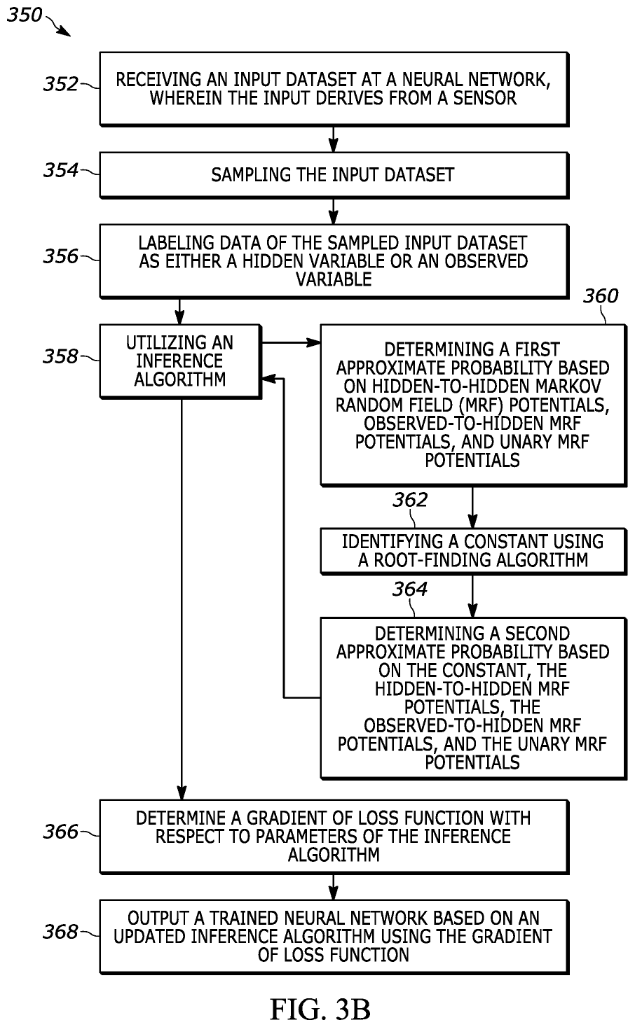

Given the above description of the monotone mean-field inference in deep Markov random fields, along with the structural examples of FIGS. 1-2 configured to carry out the mean-field inference, the following algorithms are summarized in FIGS. 3A and 3B. FIG. 3A provides an inference (e.g., a monotone mean-field inference) algorithm 300 for the neural network, and FIG. 3B provides an algorithm 302 for training the inference algorithm of FIG. 3A. These algorithms can be carried out using the structure described in FIGS. 1-2, for example a processor and associated memory and input/output interface utilized in a neural network setting.

Referring to FIG. 3A, at 302, one or more inputs are received at the neural network. The inputs may be from a sensor, such as a camera, a lidar, a radar, a pressure sensor, and/or one of the many other sensors disclosed herein (e.g., see FIGS. 5-11).

At 304, a first approximate probability is determined based on hidden-to-hidden MRF potentials (e.g., Φₕₕ), observed-to-hidden MRF potentials (e.g., Φₕₒ), and unary MRF potentials (e.g., bₕ). The first approximate probability can be determined by, for example

\tilde{q}ₕ^{(t)}:=(1−a)qₕ^{(t-1)}+a(Φₕₕqₕ^{(t-1)}+Φₕₒxₒ+bₕ)

where t=1 for the first approximate probability, but increases with each successive iteration. The hidden-to-hidden MRF potentials may be pairwise MRF potentials, and the observed-to-hidden MRF potentials may be pairwise MRF potentials (e.g., rather than large groups).

At 306, a constant (e.g., λ^{(t)}) is initialized or identified. This can be done using a root-finding algorithm, such as Newton's method described above. For example, until Newton's method converges, for i=1, . . . , k:, evaluate g(xᵢ+λ^{(t)}) using Halley's method, and overwrite λ^{(t)} with the output from one iteration of Newton's method on Σᵢ exp g(xᵢ+λ^{(t)})−1.

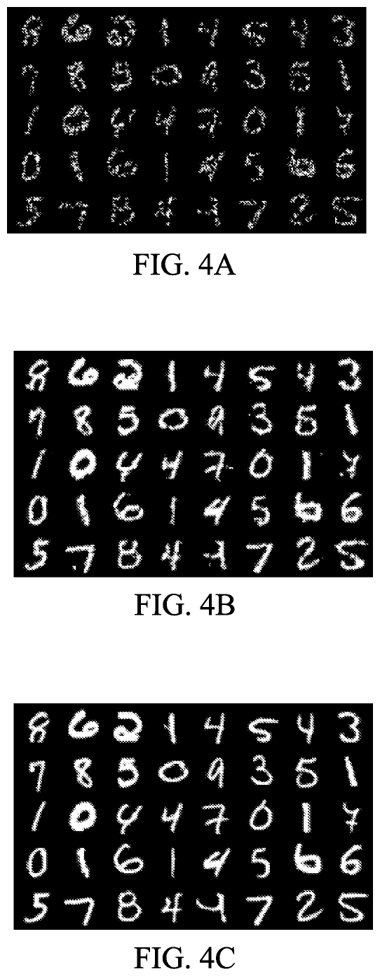

At 308, a second approximate probability (e.g., a new iteration of the approximate probability) is determined based on the constant, along with the hidden-to-hidden MRF potentials, the observed-to-hidden MRF potentials, and the unary MRF potentials. For example, qₕ^{(t)}:=prox_{f}^{a}(\tilde{q}ₕ^{(t)}) is determined using λ^{(t)}. The final approximate probability can be represented by qₕ*=qₕ^{(t)}. Finally, at 310, the input can be supplemented based on the second approximate probability to produce an output. In the context of an image (which will be described with reference to FIGS. 4A-4C), an input may include image data that has noise or other interference such that the image of the true object cannot accurately be depicted by the image data. Using the steps outlined in FIG. 3A, the input can be supplemented based on iterations of the approximate probability determination to produce an output, which, in this example, may be an image of higher quality (e.g., less interference or noise) that more accurately represents the true object attempted to be shown by the input image.

It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions.

FIG. 3B illustrates a method 350 of training a monotone mean-field model for a neural network, which can again be performed using the structure described herein. At 352, an input dataset (e.g., X) is received at a neural network. The input contained in the input dataset can be from a sensor, such as one of those described herein. At 354, the input dataset is sampled. In other words, a sample x is taken from the dataset X. At 356, the data sampled can be labeled as either a hidden variable or an observed variable. In an embodiment, the set of hidden variables xₕ is selected in x, and the remaining variables are denoted observed variables xₒ. Then, at 358, the inference algorithm from 304, 306, and 308 can be utilized. In other words, at 360, a first approximate probability is determined based on hidden-to-hidden Markov random field (MRF) potentials, observed-to-hidden MRF potentials, and unary MRF potentials; at 362, a constant (e.g., λ^{(t)}) is identified using a root-finding algorithm; and at 364, a second approximate probability is determined based on the constant, the hidden-to-hidden MRF potentials, the observed-to-hidden MRF potentials, and the unary MRF potentials. In other words, the mean-field inference is solved to find qₕ* using xₒ. Steps 360-364 can be repeated as necessary or as commanded/programmed, and then the algorithm can proceed to 366.

In embodiments, the marginal distributions are scaled by their temperature. In other words, qᵢ*←qᵢ^{τ}^{ᵢ}*, where τᵢ is a temperature parameter. A loss function (e.g., [symbol] (qₕ*, xₕ)) may be calculated, and at 366, a gradient of loss function is determined with respect to the parameters of the inference algorithm. For example,

$$\frac{\partial ℓ ( {q}_{h}^{*} , {x}_{h} )}{\partial θ} .$$

Then, at 368, a trained neural network is output based on an updated inference algorithm using the gradient of loss function. For example, model parameters using model parameter gradients

$$\frac{\partial ℓ ( {q}_{h}^{*} , {x}_{h} )}{\partial θ}$$

and an optimization algorithm Optlike stochastic gradient descent, Adam, or any other neural network optimization algorithm.

Thus, according to the embodiments described herein, a type of probabilistic model (e.g., MRF) is used herein. MRFs are used to model high-dimensional probability distributions and offer a framework under which to perform conditional inference using a process termed mean-field inference. A benefit of the embodiments of the invention disclosed throughout is an alternative to mean-field inference that is both (a) more computationally efficient, and (b) has better convergence properties. Previous attempts to provide alternatives to mean-field inference do not have better convergence properties; they either cannot guarantee that they will converge to the mean-field global minimum, or they can guarantee that they will converge to the global minimum of some loss surface, but not necessarily to the specific global minimum of the optimization problem considered in mean-field inference.

In this disclosure, the recurrence used in the monDEQ with the following recurrence:

qₕ^{(t)}=prox_{f}^{a}((1−a)qₕ^{(t-1)}+a(Φₕₕqₕ^{(t-1)}+Φₕₒxₒ+bₕ))

where:

$${prox}_{f}^{α} ( x ) = \frac{α}{1 - α} W ( \frac{1 - α}{α} exp ( \frac{{x}_{i} - α + λ}{α} ) )$$

In this, the constant A is the unique solution such that Σᵢ prox_{f}^{a}(xᵢ)=1 and W is the principal branch of the Lambert W function. Directly calculating the above can be numerically unstable, so instead, this disclosure contemplates computing the following:

$$ℊ ( y ) = log \frac{α}{1 - α} W ( \frac{1 - α}{α} exp ( \frac{y}{α} - 1 ) )$$

which can be computed using Halley's method, for example.

To find the correct value of A, Newton's method (for example) can be used to find the root of Σᵢ exp(g(xᵢ+λ^{(t)})−1 and the solution to this satisfies the above condition that Σᵢ prox_{f}^{a}(xᵢ)=1.

FIGS. 4A-4C illustrate use of the systems and methods disclosed herein, e.g., the monotone mean-field inference in MRFs. FIG. 4A represents an image as detected from a camera or other image data source. Notice the amount of fuzziness or interference on the image, which in application can be due to something covering or otherwise interfering with the camera, or other noise propagating which causes the image to not clearly represent the underlying objects in the image (in this case, numbers). FIG. 4B represents a reconstructed image utilizing the mean-field inference in MRFs described herein, which much more clearly represents the true image with no disturbances or interference (which is shown in FIG. 4C).

FIG. 5 depicts a schematic diagram of an interaction between computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

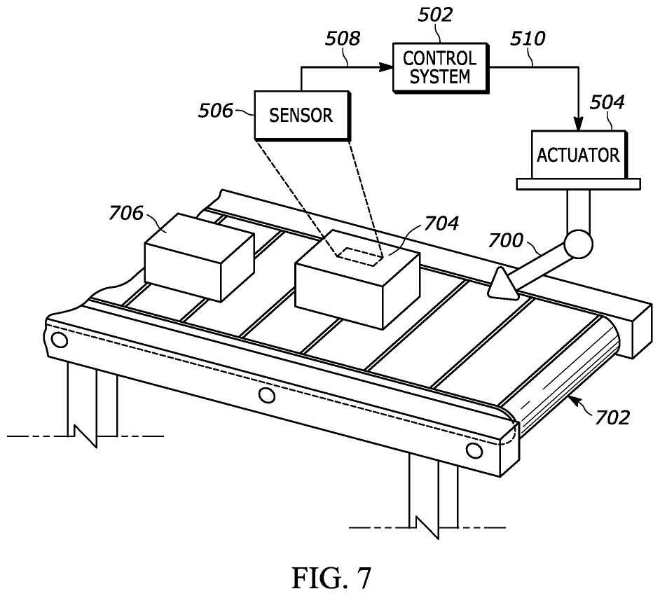

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 106 of system 700 (e.g., manufacturing machine) depending on the determined state of manufactured product 704.

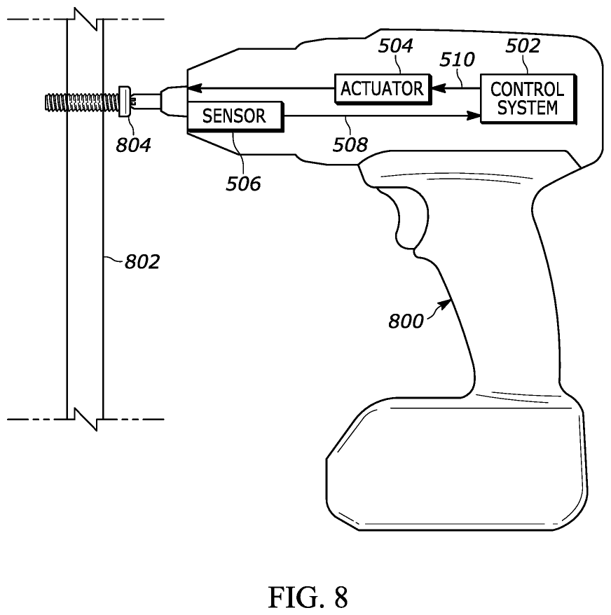

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

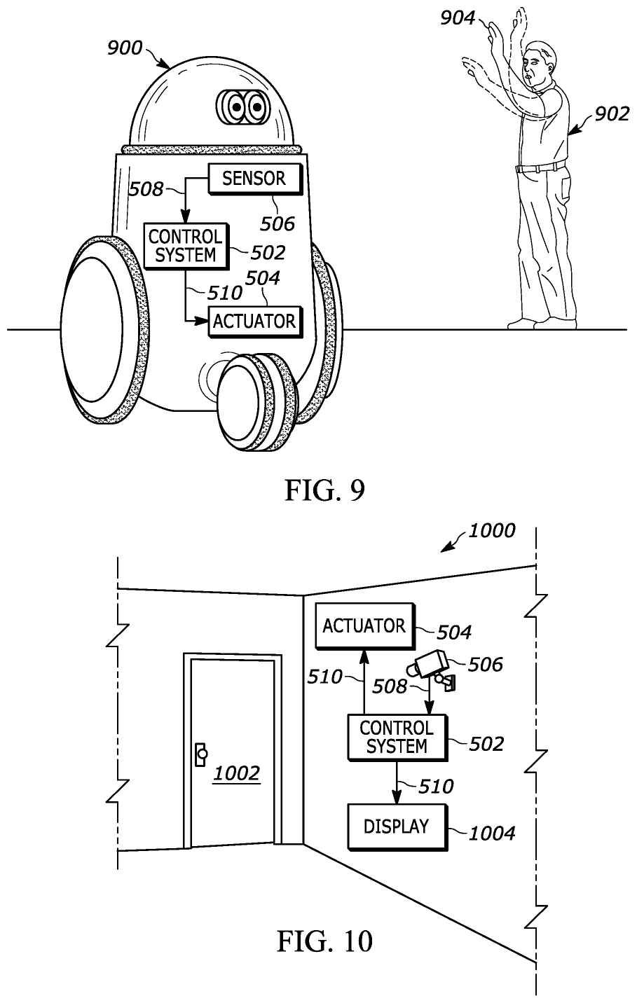

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

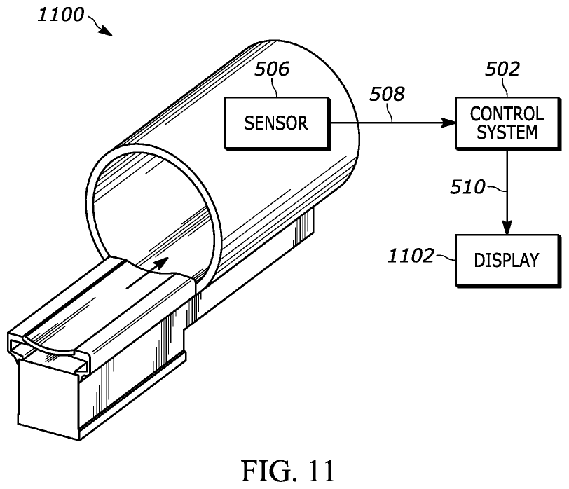

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 302 to display the imaging and highlighting the potentially anomalous region.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for inferring data to supplement an input utilizing a neural network, the computer-implemented method comprising:
receiving an input from a sensor at the neural network;
determining a first approximate probability based on hidden-to-hidden Markov random field (MRF) potentials, observed-to-hidden MRF potentials, and unary MRF potentials;
identifying a constant using a root-finding algorithm;
determining a second approximate probability based on the constant, the hidden-to-hidden MRF potentials, the observed-to-hidden MRF potentials, and the unary MRF potentials; and
supplementing the input based on the second approximate probability to produce an output.

2. The computer-implemented method of claim 1, wherein the hidden-to-hidden MRF potentials are pairwise potentials, and the observed-to-hidden MRF potentials are pairwise potentials.

3. The computer-implemented method of claim 1, wherein the input includes image data.

4. The computer-implemented method of claim 1, further comprising repeating the steps of determining the first approximate probability, identifying the constant, and determining the second approximate probability until a convergence.

5. The computer-implemented method of claim 4, wherein the convergence is defined by a set number of iterations of the step of determining the first approximate probability, identifying the constant, and determining the second approximate probability.

6. The computer-implemented method of claim 4, wherein the convergence is defined by a change in the second approximate probability over iterations being below a threshold.

7. The computer-implemented method of claim 1, wherein the step of identifying the constant includes utilizing Newton's method.

8. The computer-implemented method of claim 1, wherein the input includes a damping hyperparameter.

9. A computer-implemented method of training a monotone mean-field model for a neural network, the computer-implemented method comprising:
receiving an input dataset at a neural network, wherein the input derives from a sensor;
sampling the input dataset;
labeling data of the sampled input dataset as either a hidden variable or an observed variable;
utilizing an inference algorithm by:
determining a first approximate probability based on hidden-to-hidden Markov random field (MRF) potentials, observed-to-hidden MRF potentials, and unary MRF potentials,
identifying a constant using a root-finding algorithm, and
determining a second approximate probability based on the constant, the hidden-to-hidden MRF potentials, the observed-to-hidden MRF potentials, and the unary MRF potentials;
determining a gradient of loss function with respect to parameters of the inference algorithm; and
outputting a trained neural network based on an updated inference algorithm using the gradient of loss function.

10. The computer-implemented method of claim 9, wherein the hidden-to-hidden MRF potentials are pairwise potentials, and the observed-to-hidden MRF potentials are pairwise potentials.

11. The computer-implemented method of claim 9, wherein the input dataset includes image data.

12. The computer-implemented method of claim 9, wherein the step of identifying the constant includes utilizing Newton's method.

13. The computer-implemented method of claim 9, further comprising scaling marginal distributions of the inference algorithm by their temperature.

14. A system including a machine-learning network, the system comprising:
an input interface configured to receive input data from a sensor; and
a processor in communication with the input interface and programmed to:
receive the input data from the sensor;
determine a first approximate probability based on hidden-to-hidden Markov random field (MRF) potentials, observed-to-hidden MRF potentials, and unary MRF potentials;
identify a constant using a root-finding algorithm;
determine a second approximate probability based on the constant, the hidden-to-hidden MRF potentials, the observed-to-hidden MRF potentials, and the unary MRF potentials; and
supplement the input based on the second approximate probability to produce an output.

15. The system of claim 14, wherein the hidden-to-hidden MRF potentials are pairwise potentials, and the observed-to-hidden MRF potentials are pairwise potentials.

16. The system of claim 14, wherein the sensor is a camera, a radar, a sonar, a microphone, or a pressure sensor.

17. The system of claim 14, wherein the processor is programmed to repeat the steps of determining the first approximate probability, identifying the constant, and determining the second approximate probability until a convergence.

18. The system of claim 17, wherein the convergence is defined by a set number of iterations of determining the first approximate probability, identifying the constant, and determining the second approximate probability.

19. The system of claim 17, wherein the convergence is defined by a change in the second approximate probability over iterations being below a threshold.

20. The system of claim 14, wherein the processor is further programmed to utilize Newton's method to identify the constant.
